(19) United States
(12) Patent Application Publication
(10) Pub. No.: US 2009/0070856 A1
(43) Pub. Date: Mar. 12, 2009

(54) Image forming apparatus and utilization limiting method

(75) Inventor: Akiyoshi SAKAKIBARA, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/230,935

(22) Filed: Sep. 8, 2008

(30) Foreign Application Priority Data
Sep. 11, 2007 (JP) 2007-235770
May 28, 2008 (JP) 2008-139760

(51) Int. Cl. G06F 21/00

(52) U.S. Cl. 726/2

(57) ABSTRACT

An image forming apparatus and a utilization limiting method enable flexible limitation of utilization of resources. The image forming apparatus includes a utilization condition managing unit for managing utilization condition information including a utilization condition for a resource; a resource utilization unit for enabling the resource to be utilized based on the utilization condition included in the utilization condition information in response to a user request; a privilege information managing unit for managing privilege information that defines the presence or absence of privilege of the user to the resource; and a determination unit for determining whether utilization of the resource should be granted based on the privilege information. The determination unit grants utilization of the resource based on the utilization condition information when the user has no privilege to the resource.

### BACKGROUND OF THE INVENTION

1. Field of the Invention

The present invention relates to image forming apparatuses and utilization limiting methods, and particularly to an image forming apparatus and a utilization limiting method whereby use limitation is imposed on resources.

2. Description of the Related Art

Conventionally, in order to ensure security of various resources (such as applications and information) that are managed by an image forming apparatus, access control functions are implemented. An access control function may grant utilization of a resource by an individual user within a preset range of privilege. In other words, access to a resource without privilege is automatically rejected. An example of the related art is disclosed in Japanese Laid-Open Patent Application No. 2005-092649.

Although such a conventional access control function is valid to some extent from the viewpoint of ensuring security, there has been the problem of lack of flexibility with regard to actual tasks or operations. For example, it may be desired to allow a user who has no privilege with respect to a certain application to use the application under a predetermined operation condition, where doing so involves no apparent security problems or may actually be desirable from the viewpoint of performing a certain task.

### SUMMARY OF THE INVENTION

It is a general object the present invention to provide an image forming apparatus and a utilization limiting method whereby use limitation can be imposed on resources in a flexible manner.

In one aspect, the invention provides an image forming apparatus comprising a utilization condition managing unit configured to manage utilization condition information including a utilization condition concerning a resource; a resource utilization unit configured to enable the resource to be utilized based on the utilization condition included in the utilization condition information in response to a request from a user; a privilege information managing unit configured to manage privilege information that defines a presence or absence of privilege of the user to the resource; and a determination unit configured to determine whether utilization of the resource by the user should be granted based on the privilege information. The determination unit grants utilization of the resource based on the utilization condition information when the user has no privilege to the resource.

In another aspect, the invention provides a utilization limiting method implemented in an image forming apparatus, the method comprising a resource utilization step of enabling a resource to be utilized based on a utilization condition included in utilization condition information managed by a utilization condition managing unit, in response to a request from a user; and a determination step of determining whether utilization of the resource by the user should be granted, based on privilege information that defines a presence or absence of privilege of the user to the resource, the privilege information being managed by a privilege information managing unit. The determination step includes granting utilization of the resource based on the utilization condition information when the user has no privilege to the resource.

### BRIEF DESCRIPTION OF THE DRAWINGS

These and other objects, features and advantages of the invention will be apparent to those skilled in the art from the following detailed description of the invention, when read in conjunction with the accompanying drawings in which:

FIG. 1 shows a hardware structure of an image forming apparatus (multifunction peripheral) according to a first embodiment of the invention;

FIG. 2 shows a software structure of the image forming apparatus according to the first embodiment;

FIG. 3 shows a conceptual chart illustrating the pipe and filter architecture;

FIG. 4 shows an example of combinations of filters for realizing the functions of the multifunction peripheral according to the first embodiment;

FIG. 5 shows constituent elements of a filter;

FIG. 6 shows constituent elements of an activity;

FIG. 7 shows a structure of macro information;

FIG. 8 shows a flowchart of a macro registration process;

FIG. 9 shows a diagram illustrating the macro registration process;

FIG. 10 shows an example of a macro disclosure information setting screen;

FIG. 11 shows an example of registered macro information;

FIG. 12 shows a sequence diagram of a process of executing a macro;

FIG. 13 shows a software structure of an image forming apparatus according to a second embodiment of the invention;

FIG. 14 shows a macro disclosure information setting screen according to the second embodiment;

FIG. 15A shows an upper-limit setting screen when macro is selected as the setting unit according to the second embodiment;

FIG. 15B shows an upper-limit setting screen when user/group is selected as the setting unit according to the second embodiment;

FIG. 15C shows an upper-limit setting screen when application is selected as the setting unit according to the second embodiment;

FIG. 16 shows an example of macro information that is registered according to the second embodiment; and

FIG. 17 shows a flowchart of a process of checking the number of times of utilization of a macro.

### DETAILED DESCRIPTION OF THE PREFERRED EMBODIMENTS

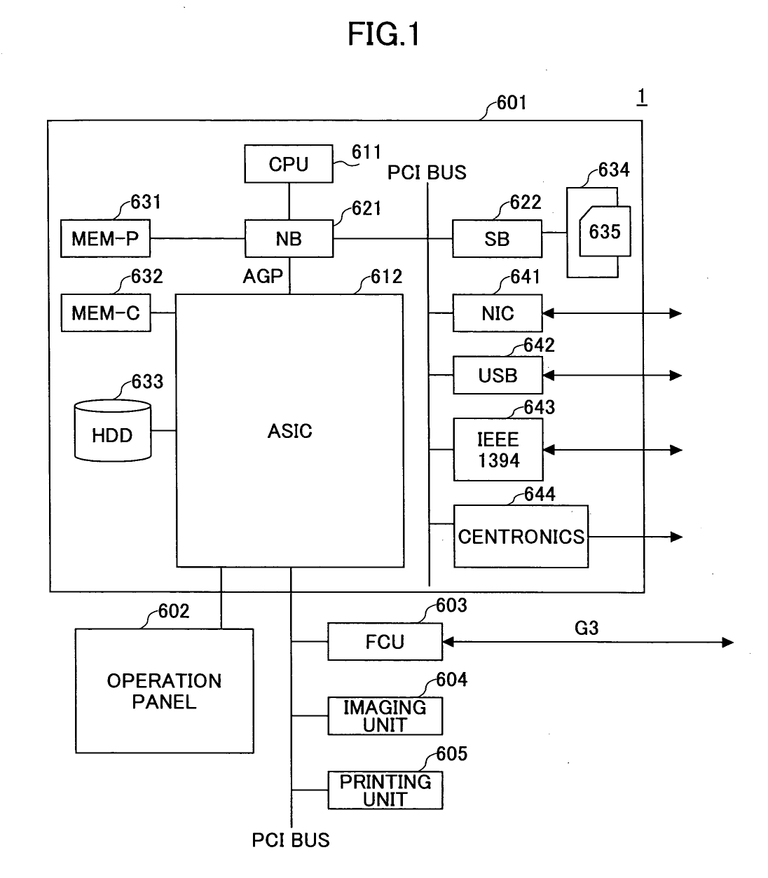

In the following, a description is given of embodiments of the present invention with reference to the attached drawings. FIG. 1 shows a hardware structure of an image forming apparatus according to an embodiment of the invention. The image forming apparatus shown in FIG. 1 is a multifunction peripheral 1 including multiple functions, such as those of a printer, a copy machine, a scanner, and a fax machine.

The multifunction peripheral 1 includes a controller 601, an operation panel 602, a facsimile control unit (FCU) 603, an imaging unit 604, and a printer unit 605 as hardware components.

The controller 601 includes a central processing unit (CPU) 611, an application specific integrated circuit (ASIC) 612, a north bridge (NB) 621, a south bridge (SB) 622, a MEM-P 631, a MEM-C 632, a hard disk drive (HDD) 633, a memory card slot 634, a network interface controller (NIC) 641, a universal serial bus (USB) device 642, an IEEE 1394 device 643, and a Centronics device 644.

The CPU 611 includes an integrated circuit (IC) for processing various information. The ASIC 612 is an IC for performing various image processes. The NB 621 is a north bridge of the controller 601. The SB 622 is a south bridge of the controller 601. The MEM-P 631 is a system memory for the multifunction peripheral 1. The MEM-C 632 is a local memory for the multifunction peripheral 1. The HDD 633 is a storage for the multifunction peripheral 1. The memory card slot 634 is a slot for setting the memory card 235. The NIC 641 is a controller for network communications using a MAC address. The USB device 642 is a device providing a connection terminal of the USB standard. The IEEE1394 device 643 provides a connection terminal of the IEEE 1394 standard. The Centronics device 644 provides a Centronics connection terminal. The operation panel 602 provides an operating unit allowing an operator to enter data into the multifunction peripheral 1 and also a display unit allowing the operator to gain an output from the multifunction peripheral 1.

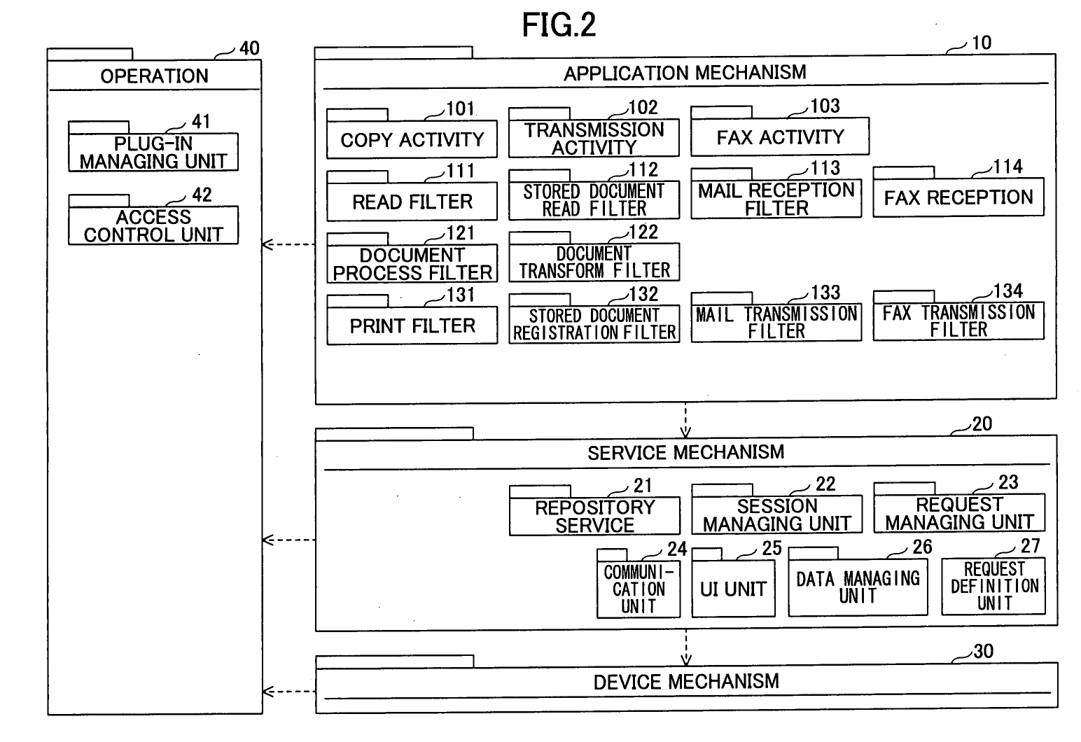

FIG. 2 shows a software structure of the image forming apparatus according to the present embodiment. As shown in FIG. 2, the multifunction peripheral 1 includes an application mechanism 10, a service mechanism 20, a device mechanism 30, and an operation unit 40 as software layers. The upper-lower relationship among the layers in FIG. 2 is based on the call relationship among the layers. Namely, basically a layer shown above calls a layer shown below.

The application mechanism 10 is a layer in which software components (programs) for allowing a user to utilize resources provided by the multifunction peripheral 1, such as functions or information (data), are implemented. In accordance with the present embodiment, some of the software components implemented in the application mechanism 10 are referred to as “filters”. This is due to the fact that the applications that execute jobs for the multifunction peripheral 1 are constructed based on a software architecture called “pipe and filter”.

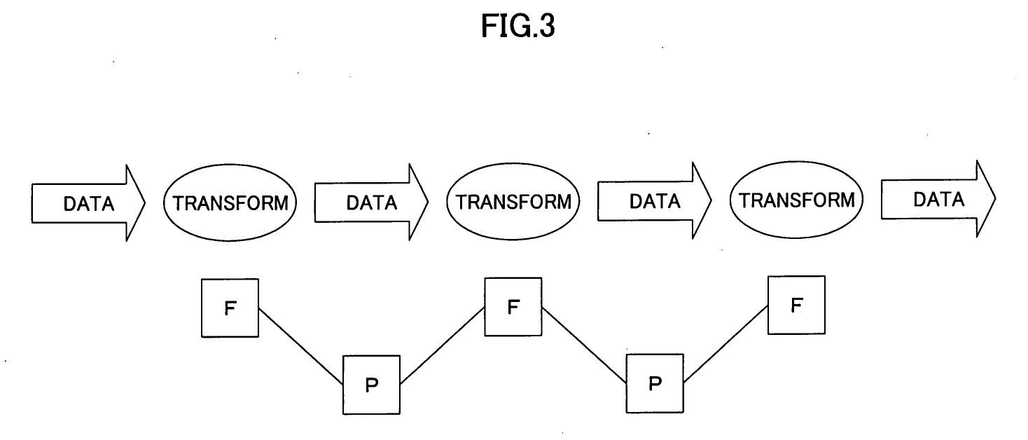

FIG. 3 illustrates the concept of pipe and filter architecture. In FIG. 3, “F” indicates a filter, and “P” indicates a pipe. The filters are connected by the pipes, as shown. The filters transform input data and output results. A pipe may be composed of a recording area that can be referenced by filters on either end, so that data outputted by one filter can be transmitted to the next filter.

Thus, in the multifunction peripheral 1 of the present embodiment, a job is considered to consist of successive transformations of a document (or data). The job in the multifunction peripheral 1 can be generalized as consisting of an input, a processing, and an output of a document. Thus, “input”, “processing”, and “output” are considered to be individual “transformations”, and a software component that realizes a single transformation is implemented as a filter. A filter that realizes the input is called an “input filter”. A filter that realizes processing is called a “processing filter”. And a filter that realizes output is called an “output filter”. Basically, an individual filter alone cannot execute a single job. Plural filters are connected as shown in FIG. 3 to construct an application for executing a job.

The individual filters are independent and basically there is no dependence relationship (call relationship) among the filters. Thus, addition (installation) or deletion (uninstallation) can be made on a filter by filter basis.

With reference to FIG. 2, the application mechanism 10 includes input filters such as a read filter 111, a stored document read filter 112, a mail reception filter 113, and a FAX reception filter 114.

The read filter 111 controls the reading of image data by a scanner, and outputs the image data that has been read. The stored document read filter 112 reads document data (image data) stored in a storage unit of the multifunction peripheral 1, and outputs the data that has been read. The mail reception filter 113 receives electronic mail and outputs data contained in the electronic mail. The FAX reception filter 114 controls FAX receptions and outputs print data that has been received.

As processing filters, there are shown a document processing filter 121 and a document transformation filter 122. The document processing filter 121 performs a predetermined image transformation process (such as layout or size changes) on input data, and outputs a result. The document transformation filter 122 transforms the data format of image data. The document transformation filter 122 may perform a rendering process, involving the transformation of PostScript data that is inputted into bit map data that is outputted.

As output filters, there are shown a print filter 131, a stored document registration filter 132, a mail transmission filter 133, and a FAX transmission filter 134.

The print filter 131 causes a plotter to output (print) data that is inputted. The stored document registration filter 132 saves data that is inputted in a storage device in the multifunction peripheral 1, such as the hard disk unit. The mail transmission filter 133 attaches data that is inputted to electronic mail and transmits the electronic mail. The FAX transmission filter 134 transmits data that is inputted via FAX.

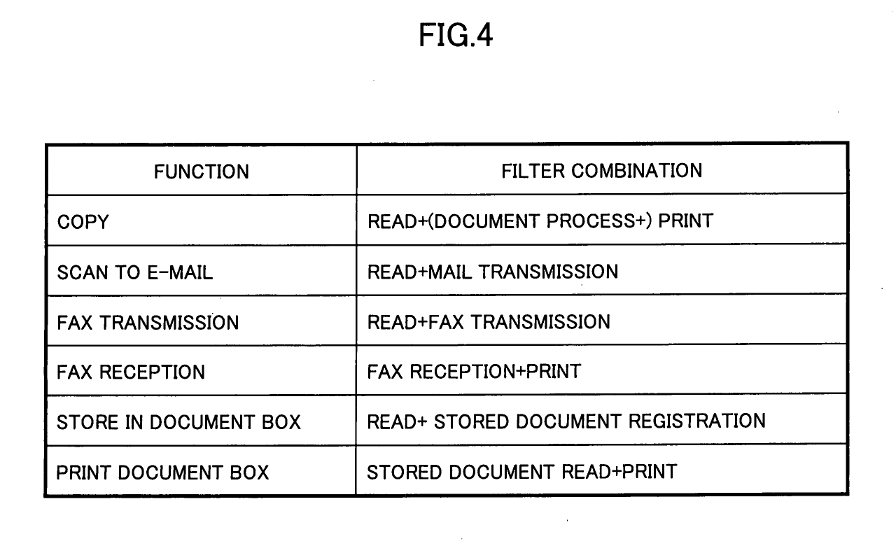

The various functions of the multifunction peripheral 1 are realized by combinations of the filters as described below. FIG. 4 shows an example of the combinations of the filters for realizing the individual functions of the multifunction peripheral 1 according to the present embodiment.

For example, a copy function is realized by connecting the read filter 111 and the print filter 131 so that image data read by the read filter 111 from a manuscript can be printed by the print filter 131. When a process such as a layout or size change is requested, the document processing filter 121 that realizes such function is inserted between the two filters.

A scan-to-email function (whereby scanned image data is transferred via electronic mail) is realized by connecting the read filter 111 and the mail transmission filter 133. A FAX transmission function is realized by connecting the read filter 111 and the FAX transmission filter 134. A FAX reception function is realized by connecting the FAX reception filter 114 and the print filter 131. A document box storing function (whereby scanned image data is saved in the multifunction peripheral 1) is realized by connecting the read filter 111 and the stored document registration filter 132. A document box printer function (whereby document data saved in the multifunction peripheral 1 is printed) is realized by connecting the stored document read filter 102 and the print filter 131.

In FIG. 4, the read filter 111, e.g., is utilized in connection with five functions. In this way, each filter can be utilized for plural functions, so that the number of development steps for realizing each function can be reduced. Furthermore, because in the multifunction peripheral 1, an application is constructed by using individual filters as components, function customization or expansion can be readily achieved. Specifically, because the individual filters have no functional dependence relationship and are independent from each other, a new application can be readily developed by adding a new filter or changing the combination of filters. Thus, when implementation of a new application is required and when part of the new application is not implemented, it is only necessary to develop and install a filter or filters that realize the missing part of the application. Therefore, with regard to layers below the application mechanism 10, the frequency of modifications that may be caused by the implementation of a new application can be reduced, thus providing a stable platform.

In the application mechanism 10, there are also provided software components called “activities”. An activity is a software component that manages the order of connection of plural filters so that a certain job can be executed by executing the filters in the certain order. One activity realizes one application.

Because the filters are highly independent from one another, it is possible to construct a combination of the filters (application) dynamically. For example, each time a job execution request is received, the filters to be used, an order of execution of the filters, and an operation condition of each of the filters, and so on, may be set by the user via the operation panel 602, so that a function desired by the user can be realized.

However, it may be bothersome if the user has to enter an execution instruction by selecting filters with regard to a function that is frequently used, such as a copy function. This problem is solved by the activity. Namely, by defining a filter combination in terms of an activity in advance, the user can select an object of execution on an activity by activity basis. A selected activity automatically executes the filters of the combination defined for the particular activity. Thus, the activity eliminates an operational complication and also provides the same sense of operation as that of a conventional user interface by which an object of execution is selected on an application by application basis.

Examples of activities shown in FIG. 2 include a copy activity 101, a transmission activity 102, and a FAX activity 103. For example, the copy activity 101 realizes the copy function (copy application) by the combination of the read filter 111, the document processing filter 121, and the print filter 131.

Basically, the individual activities are independent, and there is basically no dependence relationship (call relationship) among the activities. Therefore, addition (installation) or deletion (uninstallation) can be made on an activity by activity basis. Thus, other than the activities shown in FIG. 2, activities based on various filter combinations can be created and installed as needed.

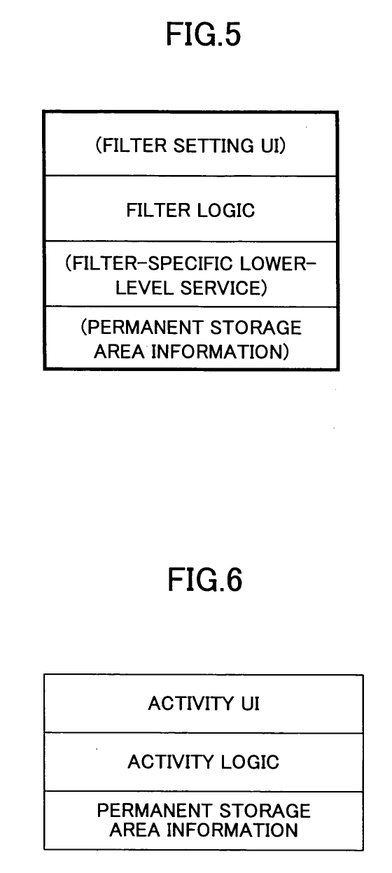

The filter and the activity are described in greater detail. FIG. 5 shows an example of constituent elements of a filter. As shown in FIG. 5, each filter is composed of a filter setting user interface (UI), a filter logic, a filter-specific lower-level service, and permanent storage area information. Among those elements, the filter setting UI, the filter-specific lower-level service, and the permanent storage area information may not be included as constituent elements in some filters.

The filter setting UI may be a program configured to cause a screen for setting filter operation conditions and the like to be displayed on the operation panel 602. The operation conditions are set on a filter by filter basis. For example, in the case of the read filter 111, the filter setting UI may correspond to a screen for setting resolution, density, image type, and so on. When the operation panel 602 is capable of display control based on HTML data or a script, the filter setting UI may comprise HTML data or a script.

The filter logic is a program in which a logic for realizing a filter function is implemented. Specifically, the filter function is realized by the constituent elements of a filter, such as the filter-specific lower-level service, the device service layer 40, and the device control layer 50, in accordance with an operation condition set via the filter setting UI. For example, in the case of the read filter 111, a corresponding filter logic controls the reading of a manuscript by the scanner.

The filter-specific lower-level service is a lower-level function (library) required for realizing a filter logic.

The permanent storage area information corresponds to a schema definition of data that needs to be saved in a nonvolatile memory, such as setting information (such as a default value of an operation condition) for a filter. The schema definition is registered in the data managing unit 26 upon installation of the filter.

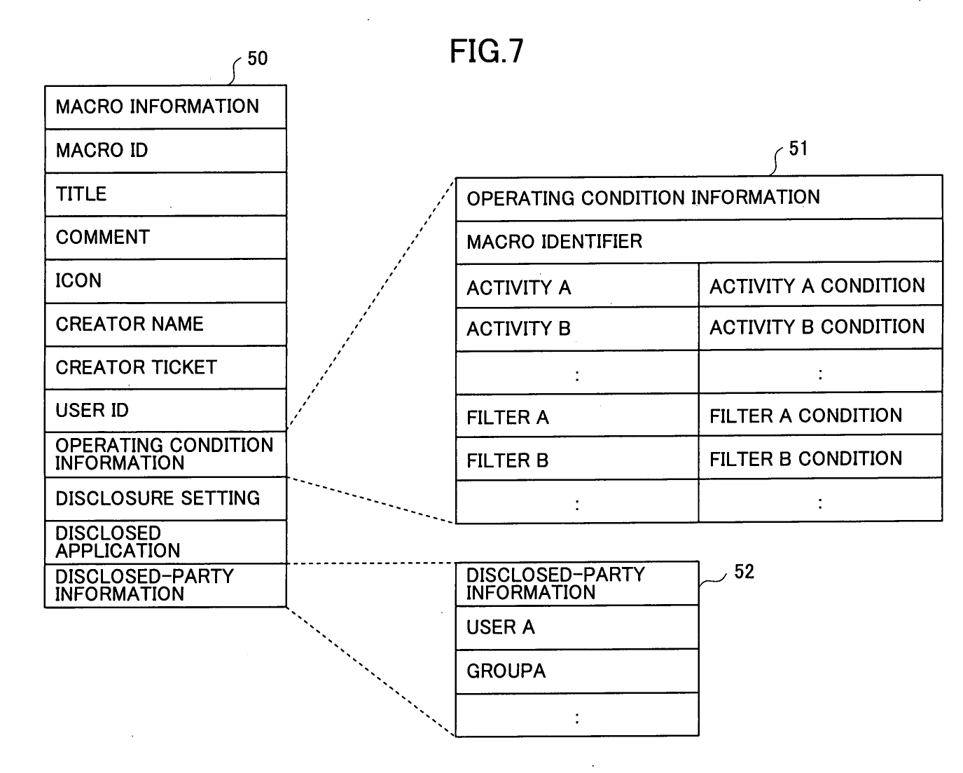

FIG. 6 shows an example of the constituent elements of an activity. As shown in FIG. 6, the activity is composed of an activity UI, an activity logic, and permanent storage area information.

The activity UI may consist of information or a program for causing a screen (such as a setting screen for setting an activity operation condition) concerning an activity to be displayed on the operation panel 602.

The activity logic is a program in which a process content of the activity is implemented. Basically, in the activity logic, there is implemented a logic concerning a filter combination (such as the order of execution of filters, settings concerning plural filters, a filter connection change, and an error process).

The permanent storage area information corresponds to a schema definition of data that needs to be saved in a nonvolatile memory, such as setting information (such as a default value of an operation condition) for an activity. The schema definition is registered in the data managing unit 26 upon installation of an activity.

Referring back to FIG. 2, the service mechanism 20 is a layer in which primitive services that may be utilized by an activity or a filter are implemented, providing a mechanism to make an application not dependent on any particular hardware specification, such as a device type. In FIG. 2, the service mechanism 20 includes a repository service 21, a session managing unit 22, a request managing unit 23, a communication unit 24, a UI unit 25, a data managing unit 26, and a request definition unit 27.

The repository service 21 provides basic operations (i.e., generation, referencing, updating, and deletion) with respect to various information saved in or outside the device, such as user information. The session managing unit 22 manages user authentication status (login status). For example, the session managing unit 22 performs user authentication based on authentication information (such as user name and password) that is entered by a user, and, upon successful authentication, issues electronic data (to be hereafter referred to as a “ticket”) validating the user. The request managing unit 23 manages jobs. The communication unit 24 controls network communications. The UI unit 25 interprets a user request entered via an operating screen displayed on the operation panel 602, and delegates a process control associated with the user request to the application mechanism 10 or the service mechanism 20, for example. The data managing unit 26 may define a method and location of storage of information that is to be managed by the repository service 21. The request definition unit 27 may generate or load (call) a macro. The “macro” herein refers to information that includes a condition of use of a resource. For example, a macro may retain a filter combination or an operation condition (utilization condition) that was set for an activity or a filter in a job that was performed in the past. A macro thus enables a user to reutilize an activity or a filter, for example, under the same operation condition as in the past, without requiring the setting of an operation condition or a filter combination or the like once again.

The device mechanism 30 includes a unit configured to control each of the devices provided in the multifunction peripheral 1.

The operation unit 40 implements software components related to the management of operation of the system. The operation unit 40 is commonly utilized by the application mechanism 10, the service mechanism 20, and the device mechanism 30. In FIG. 2, the operation unit 40 includes a plug-in managing unit 41 and an access control unit 42. The plug-in managing unit 41 manages information about software components (plug-ins) for activities or filters, for example, that can be freely attached and detached (i.e., installed and uninstalled). The access control unit 42 determines whether access to (i.e., utilization of) an activity, a filter, a macro, or information managed by the repository service 21 should be granted (i.e., whether privilege is present or absent), based on privilege information, on a user or role basis. The privilege information herein refers to the recording (definition) of the presence or absence of privilege with respect to an activity, a filter, or other resources, on a user by user basis. The privilege information is managed by the data managing unit 26.

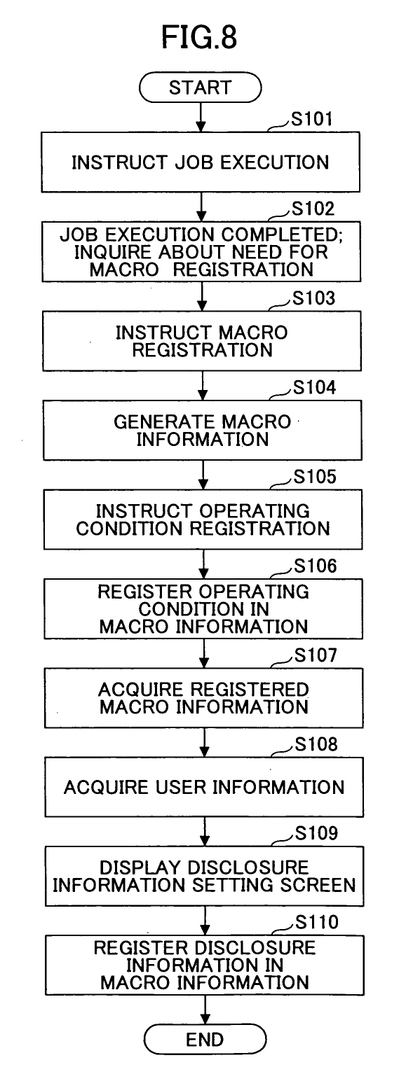

In the following, the macro is described in greater detail. FIG. 7 shows an example of a macro information structure. As shown in FIG. 7, macro information 50 includes a macro ID, a title, a comment, an icon, a creator name, a creator ticket, a user ID, an operation condition information 51, a disclosure setting, a disclosed application, and disclosed-party information 52.

The macro ID is an ID for uniquely identifying each macro. The title is a macro name designated by a user. The comment is a comment made by the user regarding the macro. The icon is displayed on a button or the like corresponding to the macro on a macro selecting screen. The creator name is a user name of a creator of the macro (i.e., the one who registered the macro). The creator ticket is a ticket of the creator. The user ID is a user ID of the creator.

The operation condition information 51 includes operation conditions associated with individual activities and filters that are executed by (i.e., registered in) a macro. The operation condition information 51 also includes a macro identifier. The macro identifier indicates that an activity or a filter is executed via a macro.

The disclosure setting includes information indicating whether a macro is to be disclosed, and also information indicating whether privilege (i.e., privilege with regard to the resources of the multifunction peripheral 1, such as an activity or filter) for executing a macro is to be limited to the privilege of the creator of the macro. Disclosure of the macro means allowing someone other than the creator of the macro to use the macro. Specifically, although in principle a creator alone has privilege to a macro that he has created, other users are also granted access to the macro when the macro is disclosed. Modes of disclosure of a macro includes a “complete disclosure” and a “within-privilege disclosure”. The complete disclosure involves no limitation of privilege when executing the macro. The within-privilege disclosure means that the privilege to execute the macro is limited to the privilege of the creator of the macro. Because a macro is registered in association with an activity, a filter, or other resources used in a job that the creator of the macro has actually executed, basically there is no possibility that a macro cannot be executed in the case of within-privilege disclosure (with the exception of a case where the privilege of the creator has been changed after registration of the macro).

As will be appreciated from the handling of privilege concerning the macro as described above, a user, when a macro is disclosed, can use an activity, a filter, or other resources via the macro even when the user does not have privilege to the macro.

In the case of the within-privilege disclosure, enhanced security can be achieved when executing a macro. For example, when macro information is illegally manipulated and an activity or the like that the macro creator has no privilege to is made available, use of such activity through the macro can be prevented.

The range of disclosure of the macro may also be limited in terms of a disclosed application or by the disclosed-party information 52. A disclosed application is an activity or a filter among the activities or filters registered in the macro that is disclosed. In other words, among the activities or the like registered in a macro, one or more can be disclosed. The disclosed-party information 52 provides a list of users or groups to which a macro is disclosed (thus allowing the use of the macro).

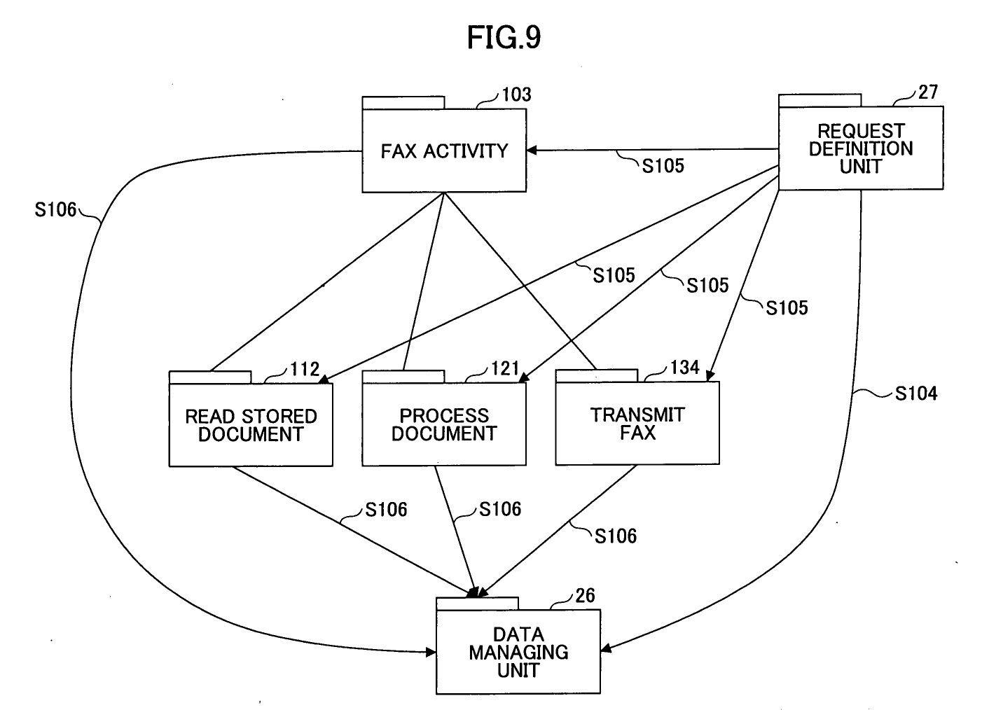

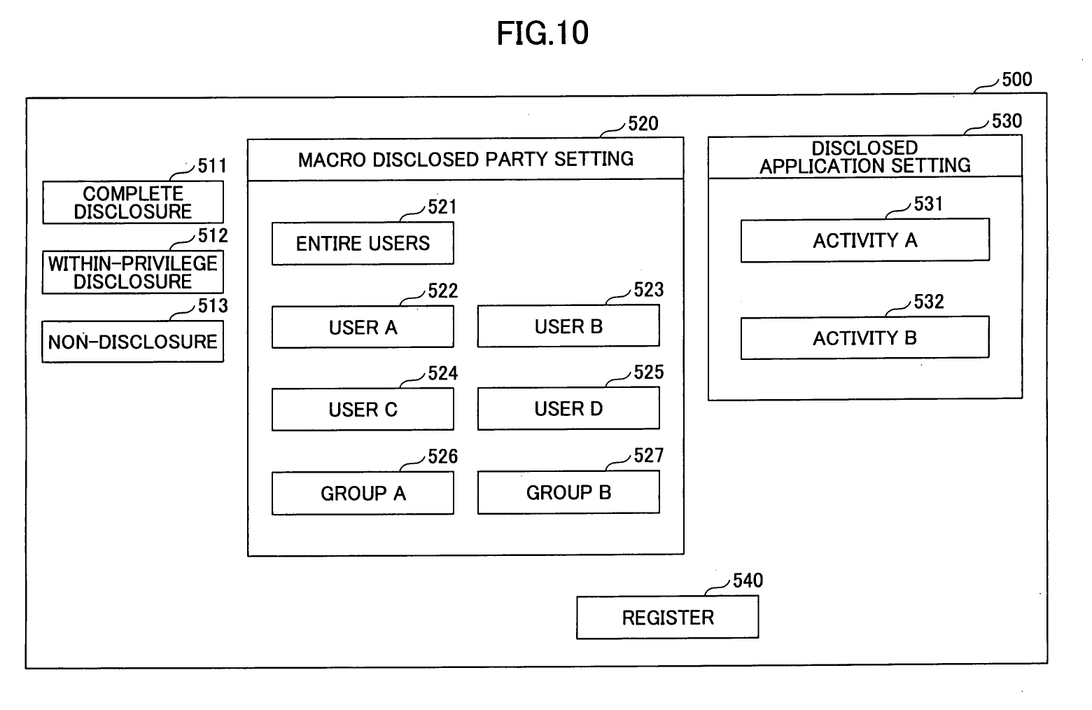

Hereafter, a description is given of a process sequence carried out with regard to a macro in the multifunction peripheral 1. FIG. 8 shows a flowchart of a macro registration process. FIG. 9 illustrates the macro registration process. In FIGS. 8 and 9, the same steps are designated with the same step numbers.

In step S101, based on an operation made by a user via the operation panel 602, an activity or a combination of filters as an object of execution is selected, and an operation condition is set for each activity or filter, and the start of execution of a job is instructed. The operation condition set by the user is retained in the activity logic for each activity (see FIG. 6) or in the filter logic of each filter (see FIG. 5).

Upon completion of the execution of the job, the UI unit 25 causes a screen to be displayed on the operation panel 602, in order to have the operator select whether a setting or settings concerning the job that has been executed are to be registered as a macro (S102). When the user instructs the registration of the macro via the screen, and a title of the macro or a comment is entered or an icon is selected, the UI unit 25 instructs the request definition unit 27 to register the macro (S103).

Thereafter, the request definition unit 27 requests the data managing unit 26 to generate macro information, based on the information entered by the user (i.e., the macro title, comment, and icon identifying information) and the user name, ticket, and user ID of the current user (i.e., the user who is currently operating the multifunction peripheral 1) (S104). As a prerequisite to the process shown in FIG. 8, the current user has been authenticated by the session managing unit 22. Therefore, the user name, ticket, and user ID of the current user are obtained by sending an inquiry to the session managing unit 22.

The data managing unit 26, in response to the request, registers the macro information in a storage unit, and returns a macro ID allocated to the macro information to the request definition unit 27. The user name, ticket, and user ID of the current user are registered as a creator name, a creator ticket, and a user ID, respectively.

Thereafter, the request definition unit 27 sends the macro ID to each activity and each filter used in the execution of the job, and instructs the registration of each operation condition in the macro information associated with the macro ID (S105). The activity that receives the operation condition registration instruction then registers the operation condition retained in the activity logic in the macro information identified by the macro ID. The filter, upon reception of the operation condition registration instruction, registers the operation condition retained in the filter logic in the macro information identified by the macro ID (S106).

Then, the request definition unit 27 acquires the macro information that has been registered in the process up to step S106, from the data managing unit 26 based on the macro ID (S107). The request definition unit 27 further acquires the user information (user list information) concerning the multifunction peripheral 1 from the repository service 21 (S108). The request definition unit 27, based on the information acquired in steps S107 and S108, causes the UI unit 25 to display the screen for setting the macro disclosure information (to be hereafter referred to as a “macro disclosure information setting screen”) on the operation panel 602 (S109).

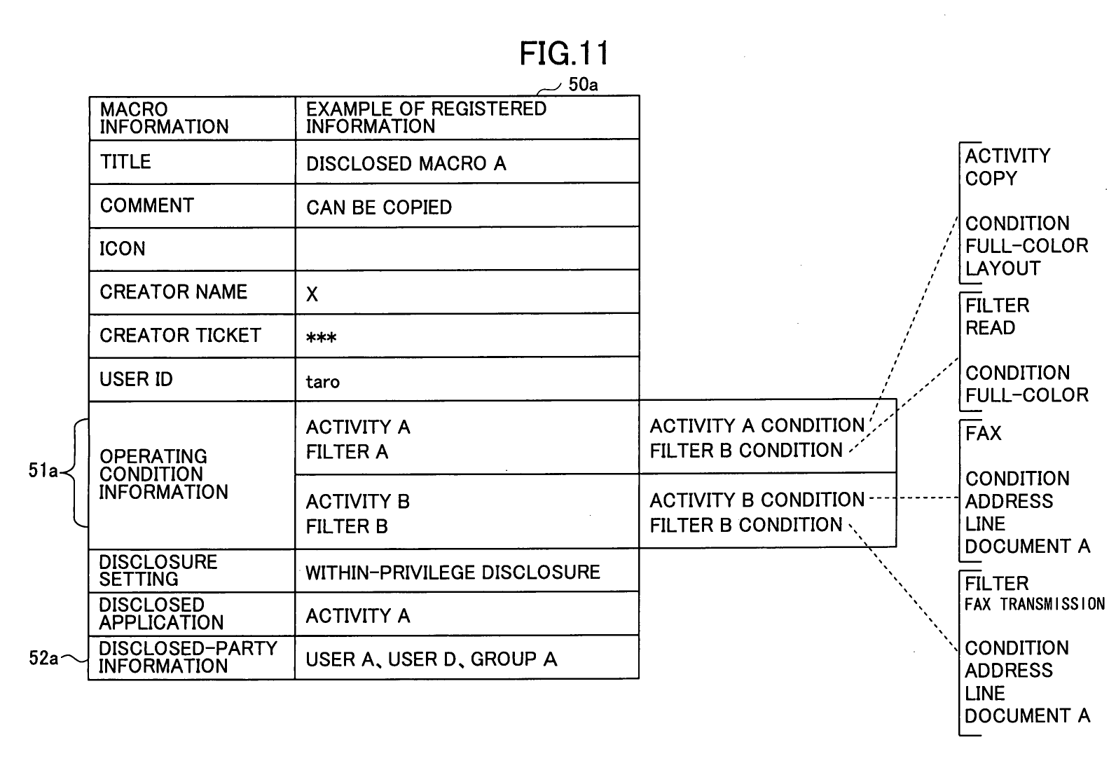

FIG. 10 shows an example of the macro disclosure information setting screen. In FIG. 10, a macro disclosure information setting screen 500 includes a complete disclosure button 511, a within-privilege disclosure button 512, a non-disclosure button 513, a disclosed-party setting area 520, a disclosed application setting area 530, and a registration button 540.

The complete disclosure button 511, the within-privilege disclosure button 512, and the non-disclosure button 513 are buttons for selecting the complete disclosure of a macro, the within-privilege disclosure of a macro, and the non-disclosure of a macro, respectively. When the complete disclosure button 511 or the within-privilege disclosure button 512 is depressed, a macro is selected as an object of disclosure, and the disclosed-party setting area 520 and the disclosed application setting area 530 are activated for input.

The disclosed-party setting area 520 is an area for selecting a macro-disclosed party. In this area, there are arranged a button 521 for selecting all of the users as the macro-disclosed party, and buttons 522 to 527 for selecting the disclosed party on a user or group basis. The buttons 522 to 527 are displayed based on the user information acquired in step S108.

The disclosed application setting area 530 is an area for setting a disclosed application. In this area, there are provided buttons 531 and 532 for selecting an individual activity utilized in a job that has been executed, as a disclosed application.

In the macro disclosure information setting screen 500, when the macro disclosure information is set and the registration button 540 is depressed, the request definition unit 27, based on the macro ID, registers the disclosure information that is set in the macro information (S110).

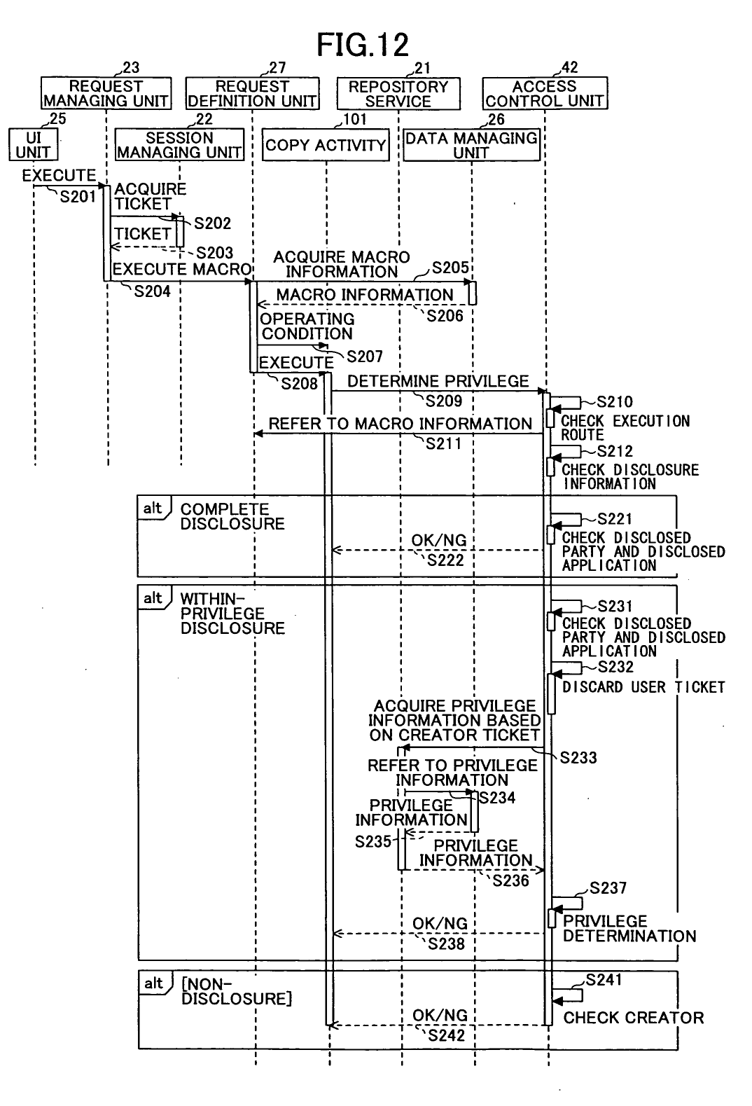

FIG. 11 shows an example of the registered macro information. In the case of macro information 50a shown in FIG. 11, operation condition information 51a includes the settings concerning operation conditions for activity A, filter A, activity B, and filter B. Specifically, the macro in accordance with the macro information 50a is for re-utilizing an application consisting of these activities or filters. The disclosure setting is “within-privilege disclosure”. The disclosed application is limited to activity A. The disclosed-party is limited to user A, user D, and group A by the disclosed-party information 52a.

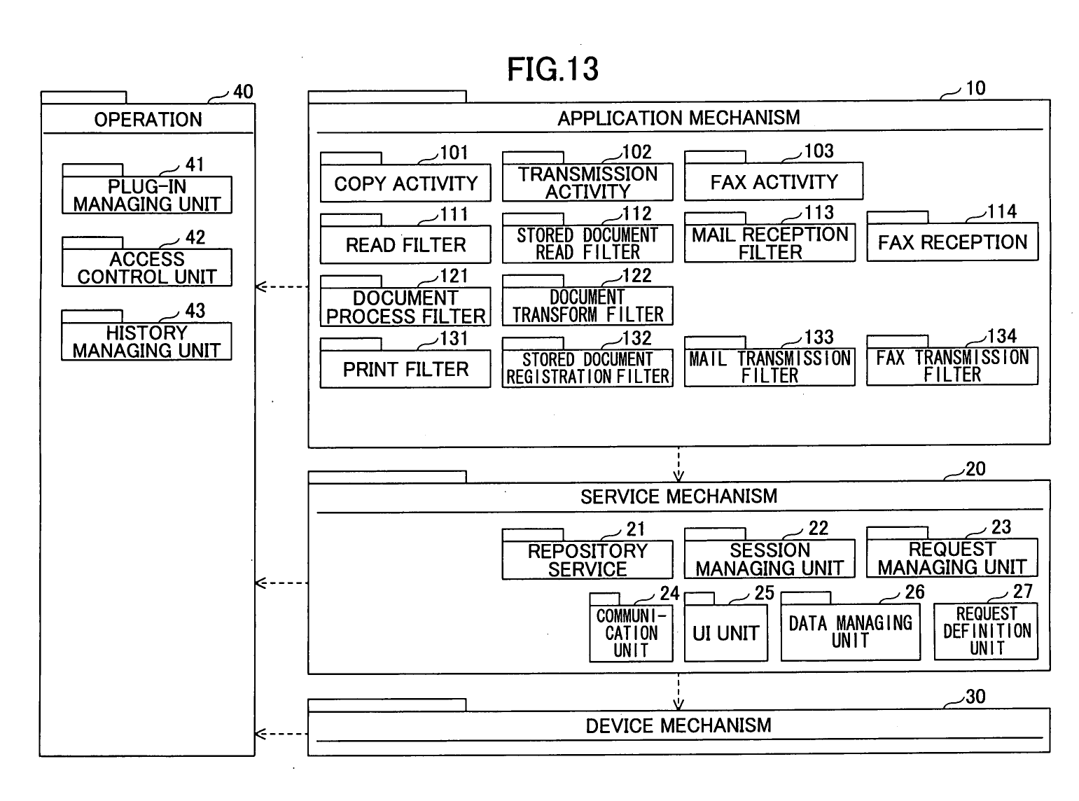

Hereafter, a description is given of a process sequence for executing a macro. FIG. 12 shows a sequence diagram for illustrating a macro execution process sequence. As a prerequisite to the process shown in FIG. 12, a current user has been authenticated by the session managing unit 22.

For example, in the macro selection screen displayed on the operation panel 602, when the user selects a macro as an object of execution and instructs the start of execution (by pressing the start key), the UI unit 25 requests the request managing unit 23 to execute the selected macro (to be hereafter referred to as a “current macro”), based on the macro ID of the current macro (S201). The display of the macro selection screen is caused by the UI unit 25 based on the list of macro information registered in the data managing unit 26.

The request managing unit 23 then acquires the ticket of the user (current user) who has made the current macro execution request, from the session managing unit 22 (S202, S203). The request managing unit 23 then requests the request definition unit 27 to execute the current macro based on the macro ID of the current macro and the ticket of the current user (S204).

The request definition unit 27, based on the macro ID, acquires the macro information of the current macro from the data managing unit 26 (S205, S206). The request definition unit 27 analyzes the operation condition information 51 in the acquired macro information, and determines an activity, a filter, and individual operation conditions that are used (i.e., made an object of execution) in the current macro. Based on the analysis result, the request definition unit 27 sets an operation condition registered in the operation condition information 51 for each activity and filter (S207). In the example of FIG. 12, a copy activity 101 is the activity used by the current macro. In this case, strictly speaking, an operation condition is set for each filter used by the copy activity 101.

The request definition unit 27, based on the operation condition information 51, requests the activity (copy activity 101) used by the current macro to execute the job (S208), while the request definition unit 27 delivers the macro identifier to the copy activity 101 as a parameter.

The copy activity 101 then queries the access control unit 42 about the presence or absence of privilege of the current user with regard to the copy activity 101 (S209). In this step, the copy activity 101 delivers the macro identifier to the access control unit 42 as a parameter.

The access control unit 42 then determines whether the copy activity 101 is being executed by the macro, based on the presence or absence of the macro identifier (S210). Namely, while each activity and filter queries the access control unit 42 about privilege whenever an execution is requested regardless of whether or not the execution is from a macro, the macro identifier is delivered to the access control unit 42 when executed from a macro, as described above. Thus, the access control unit 42 determines that the execution is from the macro when the macro identifier is delivered as a parameter.

In the case of execution from the macro, the access control unit 42 acquires macro information about the current macro from the request definition unit 27 (S211), and confirms the disclosure information in the macro information (S212). Specifically, the access control unit 42, by referring to the disclosure setting in the macro information, branches the process depending on whether the disclosure setting is for complete disclosure, within-privilege disclosure, or non-disclosure.

In the case of complete disclosure, the access control unit 42 determines whether the current user is included in the disclosed party set in the disclosed-party information 52 in the macro information, and whether the copy activity 101 is included in the disclosed application (S221). Based on the determination result, the access control unit 42 responds to the copy activity 101 as to the presence or absence of privilege (S222). Namely, when the current user is included in the disclosed party and the copy activity 101 is included in the disclosed application, the response indicates that there is privilege. When the current user is not included in the disclosed party, or the copy activity 101 is not included in the disclosed application, the response indicates that there is no privilege.

Thus, in the case of complete disclosure, the current user is allowed to utilize the copy activity 101 when the macro is disclosed to the current user, without determining the privilege of the current user with regard to the copy activity 101.

In the case of within-privilege disclosure, the access control unit 42 determines whether the current user is included in the disclosed party set in the disclosed-party information 52 in the macro information, and whether the copy activity 101 is included in the disclosed application (S231). When the current user is included in the disclosed party and the copy activity 101 is included in the disclosed application, the access control unit 42 discards the ticket of the current user (S232), and requests, based on the ticket of the creator of the current macro included in the macro information, the repository service 21 to acquire privilege information about the creator (S233). The repository service 21 then acquires the privilege information for the creator from the data managing unit 26 (S234, S235), and outputs the acquired privilege information to the access control unit 42 (S236).

The access control unit 42, based on the privilege information, determines the presence or absence of privilege to the copy activity 101 for the creator of the current macro (S237), and responds to the copy activity 101 with the determination result (S238). When it is determined in step S237 that the current user is not included in the disclosed party, or that the copy activity 101 is not included in the disclosed application, the access control unit 42 responds to the copy activity 101, indicating that there is no privilege.

Thus, in the case of within-privilege disclosure, depending on the privilege of the creator and whether the macro is disclosed to the current user, privilege to the copy activity 101 is granted to the current user.

When the macro setting is for non-disclosure, the access control unit 42 compares the creator name or user ID in the macro information with the user name or user ID of the current user, in order to determine whether the current user is the creator of the current macro (S241). Depending on the determination result, the access control unit 42 responds to the copy activity 101 indicating either the presence or absence of privilege (S242). Namely, when the current user is the creator, the response indicates that there is privilege; when the current user is not the creator, the response indicates that there is no privilege.

Thus, when the macro is set for non-disclosure, privilege to the copy activity 101 is given only to the creator of the macro. In the case of non-disclosure of macro, the macro may not be displayed on the macro selection screen as a selection candidate when the current user is not the creator.

While the foregoing description is concerned only with the determination of privilege with respect to the copy activity 101, this is merely for the sake of convenience. Thus, the process in steps following step S209 may be similarly carried out with respect to individual filters utilized by the copy activity 101.

As described above, in the multifunction peripheral 101 according to the present embodiment, utilization of a resource by a user who originally has no privilege to the resource is granted within a range of utilization conditions (operation conditions) that is defined in the macro. Thus, when it is desired to grant utilization under predetermined conditions in order to perform a task, a smooth operation can be ensured by defining a macro associated with the predetermined conditions.

Because a macro can be disclosed (i.e., its utilization is permitted) on a user by user basis, it is possible to allow only a trustworthy user to use the macro. Thus, security deterioration due to a resource becoming available via a macro without privilege can be prevented.

With regard to a macro that utilizes plural resources, because the range of disclosure can be limited to one or some of the resources, security concerning the use of resources via a macro can be ensured appropriately.

Hereafter, a description is given of a second embodiment in which a (upper) limit is imposed on the amount (number of times) of use of a disclosed macro. In the following description of the second embodiment, portions different from the first embodiment are discussed. Other features may be the same as those of the first embodiment.

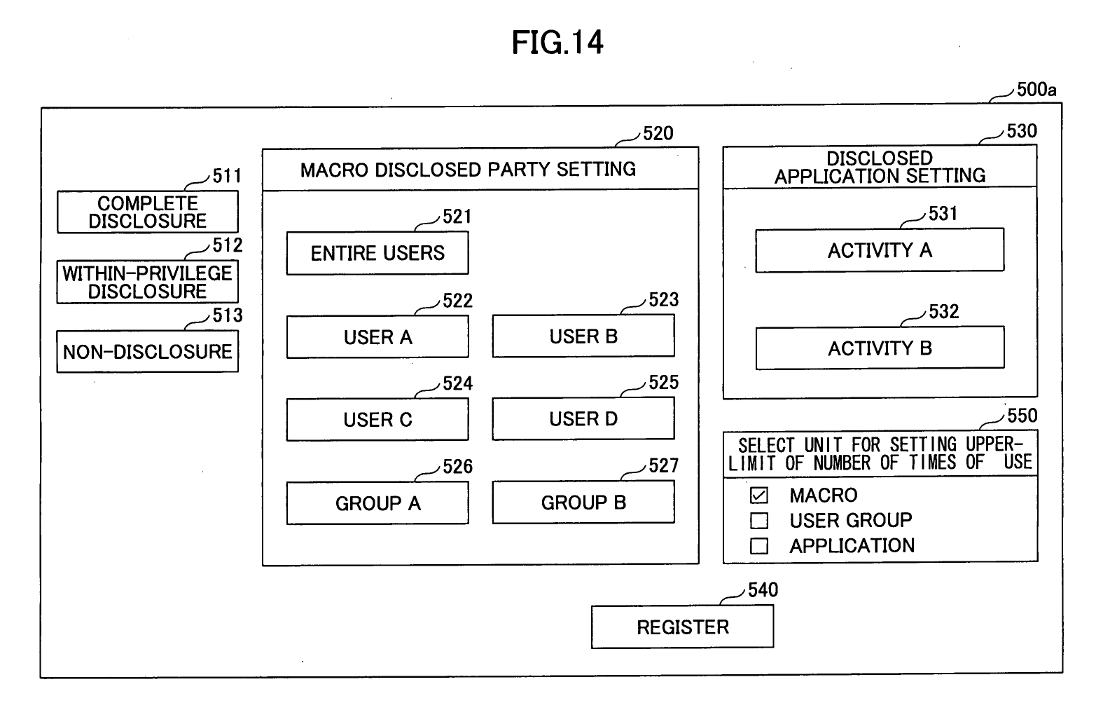

FIG. 13 shows an example of a software structure of an image forming apparatus according to the second embodiment. In FIG. 13, portions-corresponding to those shown in FIG. 2 are referenced with corresponding numerals and their discussion is omitted. The operation unit 40 of the multifunction peripheral 1 shown in FIG. 13 additionally includes a history managing unit 43.

The history managing unit 43 manages history information about various operations in the multifunction peripheral 1. Specifically, the history managing unit 43 manages the values of counters concerning the use of a macro, using a storage device, such as the HDD 633. The counters concerning the use of a macro include an individual macro counter (one counter for each macro); a user-by-user, or a group-by-group counter for each macro; and an application-by-application (activity-by-activity) counter for each macro. Updating of those counters is carried out in response to a request from the request definition unit 27 at the time of execution of a macro (FIG. 12). Specifically, when an activity (copy activity 101) is normally executed in response to an execution request in step S208, the request definition unit 27 notifies the history managing unit 43 of the ID of the macro that is currently being executed and the identifying name of the activity. The history managing unit 43 then increments the counter for the activity associated with the macro ID.

When the execution of the macro is successful in the disclosed range, the request definition unit 27 notifies the history managing unit 43 of the macro ID of the macro, the user ID of the current user, and the group ID. The history managing unit 43 then increments the counter associated with the macro ID for the individual macro, and increments the counter for the user and the counter for the group that are associated with the macro.

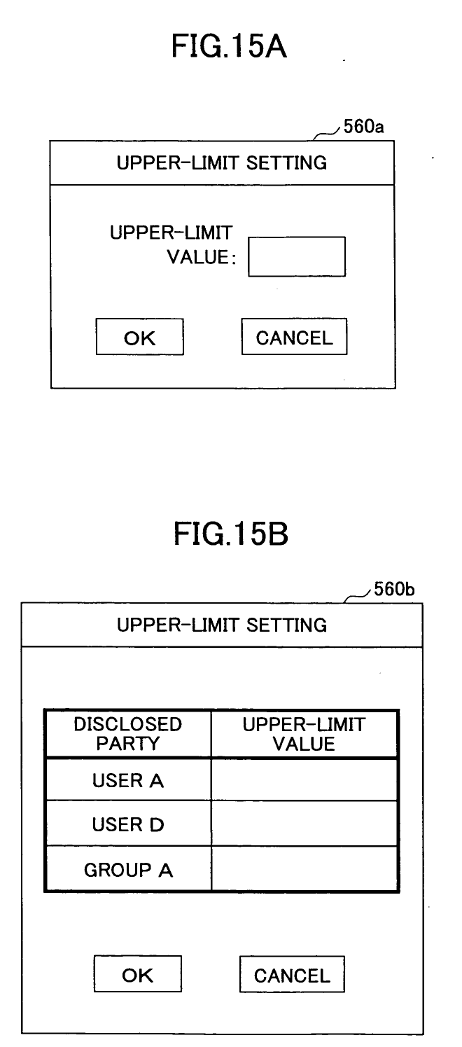

Limitation on the amount of use of macro can be set in the macro disclosure information setting screen that is displayed in step S109 of FIG. 8. FIG. 14 shows an example of the macro disclosure information setting screen in the second embodiment. In FIG. 14, portions corresponding to those shown in FIG. 10 are referenced with the corresponding numerals without their further explanations.

The macro disclosure information setting screen 500a shown in FIG. 14 additionally includes an upper-limit setting unit selection area 550. The upper-limit setting unit selection area 550 is an area for selecting the unit on which basis an upper-limit value for the number of times of utilization of a macro is set. In the present embodiment, either macro, user/group, or application may be alternatively selected as the unit on which basis an upper-limit value of the number of times of utilization of a macro is set.

When the macro is selected as the setting unit, a single upper-limit value of the number of times of utilization of a macro is set for the relevant macro (i.e., the macro for which disclosure information is set in the macro disclosure information setting screen 500a). Thus, when the macro is used by plural users, the total number of times of utilization by the plural users and the upper-limit value are compared.

When the user/group is selected as the setting unit, an upper-limit value is set for each user or group. Thus, when the macro is used by plural users, the number of times of utilization by each user or group and the upper-limit value are compared.

When the application is selected as the setting unit, an upper-limit value is set for each activity that belongs to the macro. Thus, when the macro is used by plural users, the total number of times of utilization by the plural users (i.e., the number of times of utilization via the macro) and the upper-limit value are compared for each activity.

In any of the aforementioned cases, no limit is imposed on the creator of the macro as regards the number of times of utilization. Such limitation is applied to a user or group as a macro-disclosed party.

After any of the setting units is selected in the upper-limit setting unit selection area 550 via a radio button, for example, and when the registration button 540 is depressed, the UI unit 25 causes an upper-limit setting screen to be displayed on the operation panel 602.

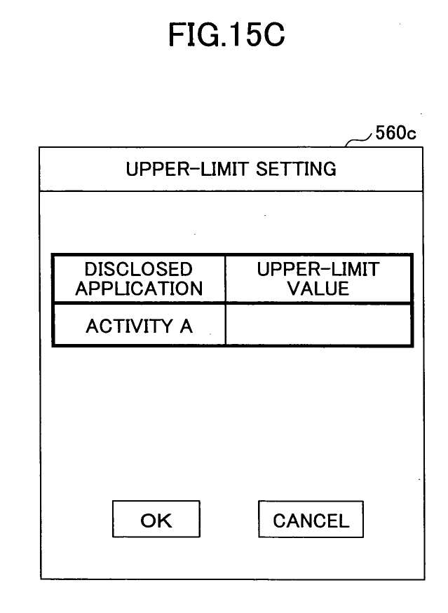

FIGS. 15A to 15C show examples of the upper-limit setting screen according to the second embodiment.

An upper-limit setting screen 560a shown in FIG. 15A is displayed when macro is selected as the setting unit. In this screen, an upper-limit value concerning the number of times of utilization of a macro can be entered.

An upper-limit setting screen 560b shown in FIG. 15B is displayed when user/group is selected as the setting unit. In this screen, an upper-limit value concerning the number of times of utilization of a macro can be entered for each user or group selected as a disclosed party in the disclosed-party setting area 520 of the macro disclosure information setting screen 500a. For those users or groups for which no upper-limit value is entered, no upper-limit value is set (i.e., the number of times of utilization is not limited).

An upper-limit setting screen 560b shown in FIG. 15C is displayed when the application is selected as the setting unit. In this screen, an upper-limit value concerning the number of times of utilization can be entered for each activity selected as a disclosed application in the disclosed application setting area 530 of the macro disclosure information setting screen 500a. For those activities for which no upper-limit value is entered, no upper-limit value is set.

When the upper-limit value is entered in any of the upper-limit setting screens 560a to 560c and an OK button is depressed, the request definition unit 27 in step S110 (FIG. 8) registers the disclosure information that is set in the macro information based on the macro ID.

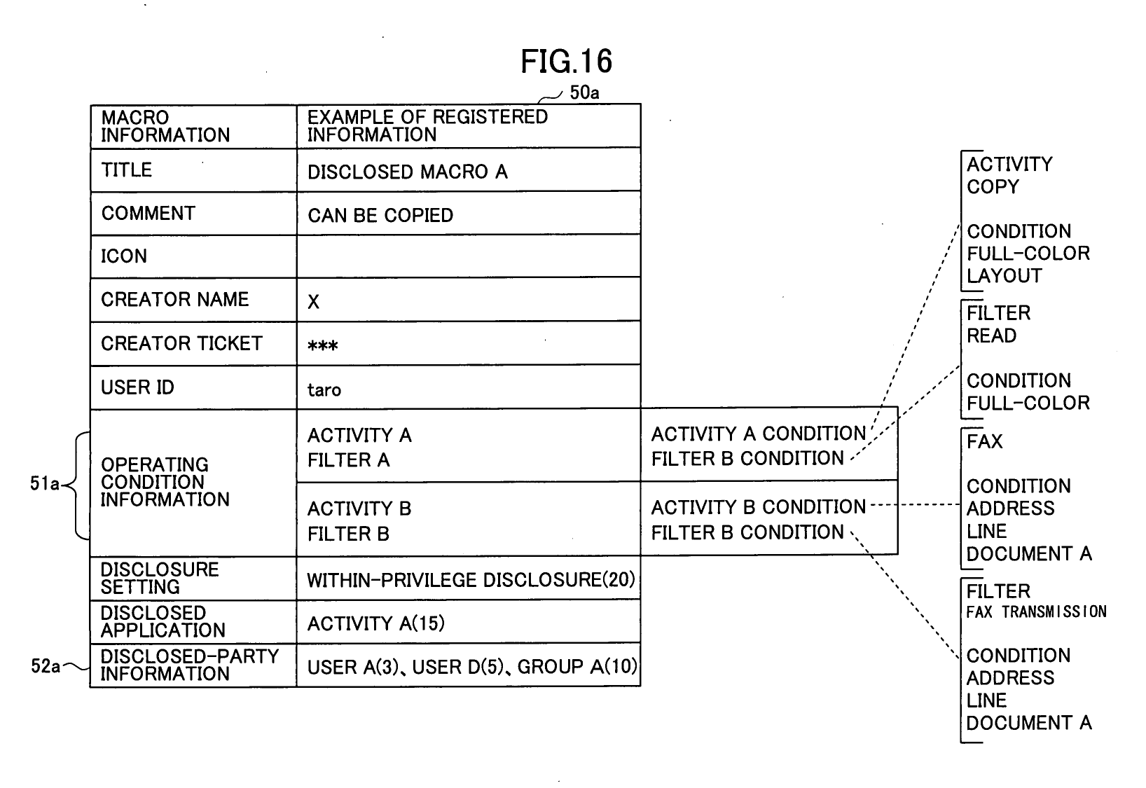

FIG. 16 shows an example of macro information registered in the second embodiment. The registered content shown in FIG. 16 is substantially identical to that shown in FIG. 11. The differences are in the disclosure setting, the disclosed application, and the disclosed-party information 52a.

Specifically, when the macro is selected as the setting unit for the upper-limit value of the number of times of utilization, and when an upper-limit value is entered in the upper-limit setting screen 560a, the upper-limit value is registered in the disclosure setting. In FIG. 16, the number “20” in the parentheses indicates the upper-limit value.

When the application is selected as the setting unit for the upper-limit value of the number of times of utilization, and when an upper-limit value is entered in the upper-limit setting screen 560c, the upper-limit value is registered in the disclosed application for each activity. In FIG. 16, the number “15” in parentheses indicates the upper-limit value.

When the user/group is selected as the setting unit for the upper-limit value of the number of times of utilization, and when an upper-limit value is entered in the upper-limit setting screen 560b, the upper-limit value is registered in the disclosed-party information 52a for each user or group. The number in parentheses similarly indicates the upper-limit value for each user or group.

The checking of the number of times of utilization (i.e., the comparison of the number of times of utilization and the upper-limit value) is carried out after steps S221 and S237 in FIG. 12 (i.e., after it is determined that the current user is included in the disclosed-party and that the activity (copy activity 101 in the case of FIG. 12) used by the macro is included in the disclosed application).

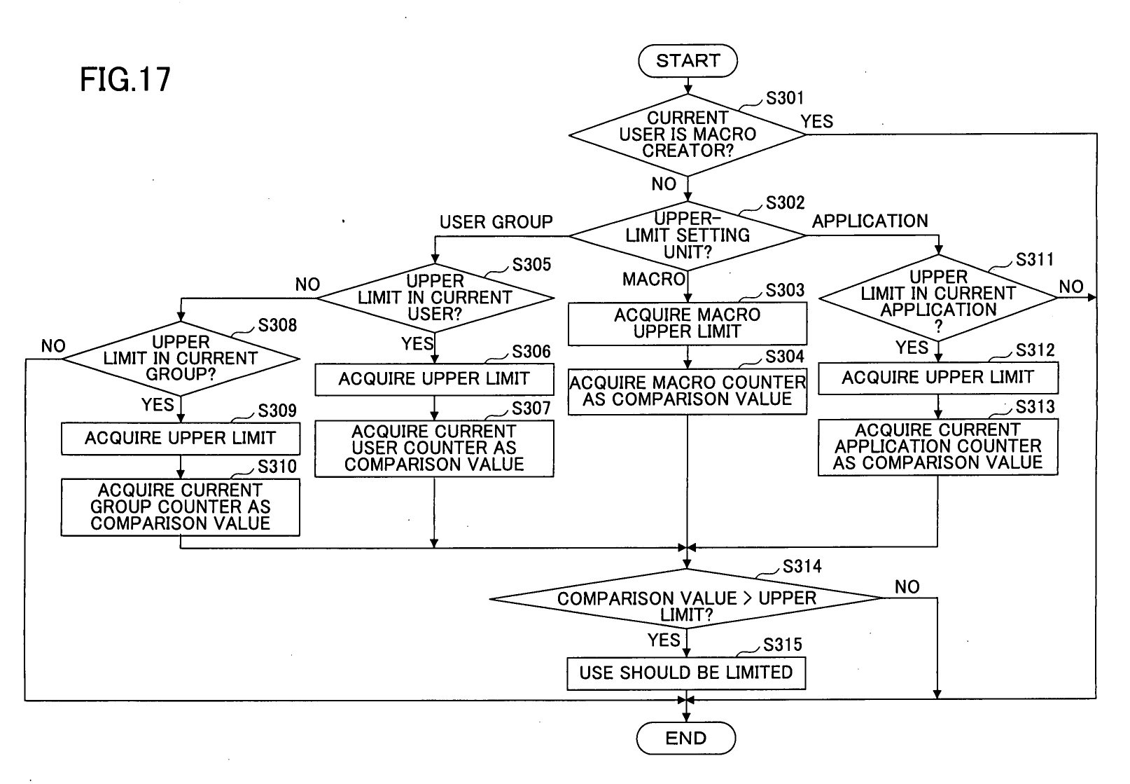

FIG. 17 shows a flowchart of a process of checking the number of times of utilization concerning a macro.

In step S301, the access control unit 42, based on the ticket of the current user and the creator of the macro information 50a (FIG. 16) of the current macro, determines whether the current user is the creator of the current macro. In the second embodiment, the ticket of the current user is not discarded in step S232. When the current user is the creator of the current macro (“Yes” in S301), no checking is conducted based on the number of times of utilization. When the current user is not the creator of the current macro (“No” in S301), the access control unit 42, based on the macro information 50a, determines the setting unit for the upper-limit value of the number of times of utilization (S302).

When the upper-limit value is registered in the disclosure setting in the macro information 50a, i.e., when the setting unit for the upper-limit value is macro (“macro” in S302), the access control unit 42 acquires the upper-limit value (S303). The access control unit 42 then acquires the value of the macro-by-macro counter for the current macro from the history managing unit 43, and designates the value as a comparison value against the upper-limit value (S304).

When the upper-limit value is registered in the disclosed-party information 52a of the macro information 50a, i.e., when the setting unit for the upper-limit value is user or group (“user/group” in S302), the access control unit 42 determines whether the upper-limit value is set for the current user in the disclosed-party information 52a (S305). When the upper-limit value is set for the current user (“Yes” in S305), the access control unit 42 acquires the upper-limit value (S306). Thereafter, the access control unit 42 acquires the value of the counter for the current user concerning the current macro from the history managing unit 43, and designates the value as a comparison value against the upper-limit value (S307). When the upper-limit value is not set for the current user (“No” in S305), the access control unit 42 determines whether the upper-limit value is set for the group (current group) to which the current user belongs in the disclosed-party information 52a (S308). The current group may be determined based on the information indicating the correspondence between the user and the group in the user information managed in the multifunction peripheral 1. When the upper-limit value is set for the current group (“Yes” in S308), the access control unit 42 acquires the upper-limit value (S309). The access control unit 42 then acquires the value of the counter for the current group concerning the current macro from the history managing unit 43, and designates the value as a comparison value against the upper-limit value (S310).

When the upper-limit value is registered in the disclosed application of the macro information 50a, i.e., when the setting unit for the upper-limit value is application (“application” in S302), the access control unit 42 determines whether the upper-limit value is set for the current application (i.e., application (activity) as an object of privilege determination (S209 in FIG. 12)) in the disclosed application of the macro information 50a (S311). When the upper-limit value is set in the current application (“Yes” in S311), the access control unit 42 acquires the upper-limit value (S312). Thereafter, the access control unit 42 acquires the value of the counter for the current application concerning the current macro from the history managing unit 43, and designates the value as a comparison value against the upper-limit value (S313).

Following step S304, S310, or S313, the access control unit 42 compares the comparison value and the upper-limit value (S314). When the comparison value exceeds the upper-limit value (“Yes” in S314), the access control unit 42 determines that the use of the current macro should be limited (S315). On the other hand, when the comparison value is below the upper-limit value (“No” in S314), or when the upper-limit value is not set in the current group (“No” in S308), or when the upper-limit value is not set in the current application (“No” in S311), the access control unit 42 determines that there is no need to limit the use of the current macro.

When it is determined that the use of the current macro should be limited, the access control unit 42, in step S222 or S237 in FIG. 12, responds to the current application (copy activity 101) that there is no privilege. Thus, in this case, the current application is not executed. When the individual applications that belong to the macro are not executed, the process of the macro as a whole is not executed.

However, even when the number of times of utilization exceeds the upper-limit value, a different limitation (such as charging of a fee) may be imposed on the current user without stopping the execution of the process. For example, the access control unit 42 may cause a message to be displayed on the UI unit 25, indicating the charging of a fee. When the user enters an input acknowledging the message, a process may be carried out. Such a message may alternatively be transmitted by mail to a mail address of the current user. In this case, a notification may be made that a fee will be charged from the next time.

As described above, in the second embodiment, use of a macro can be limited by the number of times of utilization of the macro. Thus, use of a macro can be limited flexibly.

Although this invention has been described in detail with reference to certain embodiments, variations and modifications exist within the scope and spirit of the invention as described and defined in the following claims.

The present application is based on the Japanese Priority Applications No. 2007-235770 filed Sep. 11, 2007, and No. 2008-139760 filed May 28, 2008, the entire contents of which are hereby incorporated by reference.

What is claimed is:

1. An image forming apparatus comprising:
a utilization condition managing unit configured to manage utilization condition information including a utilization condition concerning a resource;
a resource utilization unit configured to enable the resource to be utilized based on the utilization condition included in the utilization condition information in response to a request from a user;
a privilege information managing unit configured to manage privilege information that defines a presence or absence of privilege of the user to the resource; and
a determination unit configured to determine whether utilization of the resource by the user should be granted based on the privilege information,
wherein the determination unit grants utilization of the resource based on the utilization condition information when the user has no privilege to the resource.

2. The image forming apparatus according to claim 1, wherein the resource includes a program and the utilization condition information includes an operation condition concerning the program.

3. The image forming apparatus according to claim 1, wherein the utilization condition managing unit manages, in association with the utilization condition information, information indicating whether the user is allowed to utilize the utilization condition information,
wherein the determination unit does not grant utilization of the resource based on the utilization condition information when the user is not allowed to utilize the utilization condition information.

4. The image forming apparatus according to claim 3, wherein the utilization condition managing unit manages, in association with the utilization condition information, information identifying a creator of the utilization condition information,
wherein the determination unit grants utilization of the resource by the creator based on the utilization condition information.

5. The image forming apparatus according to claim 4, wherein the determination unit determines whether utilization of the resource based on the utilization condition information should be granted based on the privilege information concerning the creator.

6. The image forming apparatus according to claim 3, wherein the utilization condition information includes a utilization condition for plural resources,
wherein the utilization condition managing unit manages information identifying one or more of the plural resources of which utilization is granted based on the utilization condition information,
wherein the determination unit does not grant utilization of one or more of the resources of which utilization is not granted, even when the user is allowed to utilize the utilization condition information.

7. The image forming apparatus according to claim 1, including a number-of-times-of-utilization recording unit configured to record, in a storage device, a number of times of utilization of the utilization condition information enabled by the resource utilization unit,
wherein the determination unit does not grant utilization of the resource based on the utilization condition information when the number of times of utilization of the utilization condition information exceeds an upper-limit value that is set for the utilization condition information.

8. The image forming apparatus according to claim 7, wherein the number-of-times-of-utilization recording unit records the number of times of utilization of the utilization condition information by the user,
wherein the determination unit does not grant utilization of the resource based on the utilization condition information when the number of times of utilization by the user exceeds the upper-limit value.

9. The image forming apparatus according to claim 7, wherein the number-of-times-of-utilization recording unit records the number of times of utilization of the utilization condition information for the resource,
wherein the determination unit does not grant utilization of the resource when the number of times of utilization of the utilization condition information for the resource exceeds the upper-limit value.

10. A utilization limiting method implemented in an image forming apparatus, the method comprising:
a resource utilization step of enabling a resource to be utilized based on a utilization condition included in utilization condition information managed by a utilization condition managing unit, in response to a request from a user; and
a determination step of determining whether utilization of the resource by the user should be granted, based on privilege information that defines a presence or absence of privilege of the user to the resource, the privilege information being managed by a privilege information managing unit,
wherein the determination step includes granting utilization of the resource based on the utilization condition information when the user has no privilege to the resource.

11. The utilization limiting method according to claim 10, wherein the resource includes a program, and the utilization condition information includes an operation condition for the program.

12. The utilization limiting method according to claim 10, wherein the utilization condition managing unit manages, in association with the utilization condition information, information indicating whether the user is allowed to utilize the utilization condition information,
wherein the determination step includes not granting utilization of the resource based on the utilization condition information when the user is not allowed to utilize the utilization condition information.

13. The utilization limiting method according to claim 12, wherein the utilization condition managing unit manages, in association with the utilization condition information, information identifying a creator of the utilization condition information,
wherein the determination step includes granting utilization of the resource by the creator based on the utilization condition information.

14. The utilization limiting method according to claim 13, wherein the determination step includes determining whether utilization of the resource based on the utilization condition information should be granted based on the privilege information concerning the creator.

15. The utilization limiting method according to claim 12, wherein the utilization condition information includes a utilization condition for plural resources,
wherein the utilization condition managing unit manages information identifying one or more of the plural resources of which utilization is granted based on the utilization condition information,
wherein the determination step includes not granting utilization of one or more of the plural resources of which utilization is not granted, even when the user is allowed to utilize the utilization condition information.

16. The utilization limiting method according to claim 10, including a number-of-times-of-utilization recording step of recording, in a storage device, the number of times of utilization of the utilization condition information enabled in the resource utilization step,
wherein the determination step includes not granting utilization of the resource based on the utilization condition information when the number of times of utilization of the utilization condition information exceeds an upper-limit value that is set for the utilization condition information.

17. The utilization limiting method according to claim 16, wherein the number-of-times-of-utilization recording step includes recording the number of times of utilization of the utilization condition information by the user,
wherein the determination step includes not granting utilization of the resource based on the utilization condition information when the number of times of utilization by the user exceeds the upper-limit value.

18. The utilization limiting method according to claim 16, wherein the number-of-times-of-utilization recording step includes recording the number of times of utilization of the utilization condition information for the resource,
wherein the determination step includes not granting utilization of the resource when the number of times of utilization of the utilization condition information for the resource exceeds the upper-limit value.
